(19) United States
(12) Patent Application Publication
(10) Pub. No.: US 2025/0348221 A1
(43) Pub. Date: Nov. 13, 2025

(54) Data Migration in Memory Systems

(71) Applicant: Yangtze Memory Technologies Co., Ltd., Wuhan (CN)

(72) Inventors: Hua TAN, Wuhan (CN); Xiongbin CHEN, Wuhan (CN); Mo CHENG, Wuhan (CN); Tianyi WANG, Wuhan (CN)

(21) Appl. No.: 18/790,029

(22) Filed: Jul. 31, 2024

Related U.S. Application Data
(63) Continuation of application No. PCT/CN2024/092571, filed on May 11, 2024.

(51) Int. Cl. G06F 3/06; G06F 12/02

(52) U.S. Cl. CPC G06F 3/0613; G06F 3/0647; G06F 3/0679; G06F 12/0246; G06F 2212/7202

(57) ABSTRACT

Example systems and methods for data migration in memory systems are disclosed. One example method includes receiving, by a memory controller of a memory system, a command comprising a first logical address and a second logical address. In response to the command, a correspondence of data to the second logical address is established based on a correspondence of the data to the first logical address. The first logical address is deallocated based on the command.

### CROSS-REFERENCE TO RELATED APPLICATIONS

This application is a continuation of International Application No. PCT/CN2024/092571, filed on May 11, 2024, the disclosure of which is hereby incorporated by reference in its entirety.

### TECHNICAL FIELD

The present disclosure relates to memory devices, systems, and methods for data migration in memory systems.

### BACKGROUND

The management of a file system in a host (e.g., a computing system) can include data migration in a memory system that couples to the host and stores data and/or files in the file system. Examples of managing the file system can include data defragmentation and/or garbage collection. Data migration can include the host sending a command to the memory system to establish a correspondence of data to a destination logical address based on a correspondence of the data to a source logical address. A logical address can also be referred to as a logical block address (LBA) or a LBA range.

### SUMMARY

The present disclosure relates to memory devices, systems, and methods for data migration in memory systems.

Certain aspects of the subject matter described here can be implemented as a system. The system includes a host and a memory system coupled to the host. The host is configured to send a command that includes a first logical address and a second logical address. The memory system is configured to receive the command, establish, in response to the command, a correspondence of data to the second logical address based on a correspondence of the data to the first logical address, and deallocate the first logical address based on the command.

The system can include one or more of the following features.

In some implementations, establishing the correspondence of the data to the second logical address based on the correspondence of the data to the first logical address includes reading the data from a first physical storage space of the memory system corresponding to the first logical address, writing the data to a second physical storage space of the memory system, and establishing a mapping relationship between the second logical address and the second physical storage space.

In some implementations, establishing the correspondence of the data to the second logical address based on the correspondence of the data to the first logical address includes establishing a mapping relationship between the second logical address and a first physical storage space of the memory system corresponding to the first logical address.

In some implementations, deallocating the first logical address based on the command includes cancelling the correspondence of the data to the first logical address.

In some implementations, the command includes a flag bit indicating whether to deallocate the first logical address.

In some implementations, the memory system is configured to deallocate the first logical address in response to the flag bit including a first value.

In some implementations, the memory system is configured to retain the correspondence of the data to the first logical address in response to the flag bit including a second value.

In some implementations, the command includes a copy command having the flag bit.

In some implementations, the memory system is further configured to send a response signal to the host in response to a completion of an execution of the command, and upon receiving a read command instructing reading out the data corresponding to the first logical address following the completion of the execution of the command, return an invalid data or other data different from the data.

In some implementations, the host includes an interface that includes a driver and an interconnector. The interconnector is coupled to the driver and the memory system. The driver is configured to generate the command that complies with protocol standards based on a request from an operating system in the host. The interconnector is configured to transfer the command to the memory system through a communication bus.

In some implementations, the memory system includes a Non-Volatile Memory Express (NVMe) device or a universal flash storage (UFS) device.

Certain aspects of the subject matter described here can be implemented as a system. The system includes a host and a memory system coupled to the host. The host is configured to send a command with a flag bit. The command includes a first logical address and a second logical address. The memory system is configured to establish, in response to the command received from the host, a correspondence of data to the second logical address based on a correspondence of the data to the first logical address, and determine whether to deallocate the first logical address based on the flag bit.

The system can include one or more of the following features.

In some implementations, deallocating the first logical address in response to the flag bit including a first value, or retain the correspondence of the data to the first logical address in response to the flag bit including a second value.

In some implementations, establishing the correspondence of the data to the second logical address based on the correspondence of the data to the first logical address includes reading the data from a first physical storage space of the memory system corresponding to the first logical address, writing the data to a second physical storage space of the memory system, and establishing a mapping relationship between the second logical address and the second physical storage space.

In some implementations, establishing the correspondence of the data to the second logical address based on the correspondence of the data to the first logical address includes establishing a mapping relationship between the second logical address and a first physical storage space of the memory system corresponding to the first logical address.

Certain aspects of the subject matter described here can be implemented as a memory system. The memory system includes a non-volatile memory device and a memory controller coupled to the non-volatile memory device and configured to receive a command that includes a first logical address and a second logical address, establish, in response to the command, a correspondence of data to the second logical address based on a correspondence of the data to the first logical address, and deallocate the first logical address based on the command.

The memory system can include one or more of the following features.

In some implementations, the memory controller includes a first interface coupled to a host and configured to receive and decode the command, and a processor coupled to the first interface and configured to establish the correspondence of the data to the second logical address based on the correspondence of the data to the first logical address and deallocate the first logical address based on the command.

In some implementations, establishing the correspondence of the data to the second logical address based on the correspondence of the data to the first logical address includes sending, to the non-volatile memory device, a read command to read the data from a first physical storage space of the non-volatile memory device, sending, to the non-volatile memory device, a write command to write the data to a second physical storage space of the non-volatile memory device, and establishing a mapping relationship between the second logical address and the second physical storage space.

In some implementations, establishing the correspondence of the data to the second logical address based on the correspondence of the data to the first logical address includes establishing a mapping relationship between the second logical address and a first physical storage space of the non-volatile memory device corresponding to the first logical address.

In some implementations, deallocating the first logical address based on the command includes cancelling the correspondence of the data to the first logical address.

In some implementations, the command includes a flag bit indicating whether to deallocate the first logical address.

In some implementations, the memory controller is configured to deallocate the first logical address in response to the flag bit including a first value.

In some implementations, the memory controller is configured to retain the correspondence of the data to the first logical address in response to the flag bit including a second value.

In some implementations, the memory controller is configured to send a response signal to a host in response to a completion of an execution of the command, and upon receiving a read command instructing reading out the data corresponding to the first logical address following the completion of the execution of the command, return an invalid data or other data different from the data.

Certain aspects of the subject matter described here can be implemented as a method. The method includes receiving, by a memory controller of a memory system, a command that includes a first logical address and a second logical address. In response to the command, a correspondence of data to the second logical address is established based on a correspondence of the data to the first logical address. The first logical address is deallocated based on the command.

The method can include one or more of the following features.

In some implementations, establishing the correspondence of the data to the second logical address based on the correspondence of the data to the first logical address includes reading the data from a first physical storage space of a non-volatile memory device of the memory system corresponding to the first logical address, writing the data to a second physical storage space of the non-volatile memory device, and establishing a mapping relationship between the second logical address and the second physical storage space.

In some implementations, establishing the correspondence of the data to the second logical address based on the correspondence of the data to the first logical address includes establishing a mapping relationship between the second logical address and a first physical storage space of a non-volatile memory device of the memory system corresponding to the first logical address.

In some implementations, deallocating the first logical address based on the command includes cancelling the correspondence of the data to the first logical address.

Certain aspects of the subject matter described here can be implemented as a non-transitory computer storage medium. The non-transitory computer storage medium stores instructions that, when executed in a memory system, causes the memory system to perform operations. The operations include receiving, by a memory controller of the memory system, a command that includes a first logical address and a second logical address, establishing, in response to the command, a correspondence of data to the second logical address based on a correspondence of the data to the first logical address, and deallocating the first logical address based on the command.

Certain aspects of the subject matter described here can be implemented as a host. The host includes a driver and an interconnector coupled to the driver. The driver is configured to generate a command indicating establishing a correspondence of data to a second logical address based on a correspondence of the data to a first logical address and deallocating the first logical address. The interconnector is configured to send the command through a communication bus.

The details of these and other aspects and implementations of the present disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 illustrates a block diagram of an example system having a memory device, according to some aspects of the present disclosure.

FIG. 2 illustrates an example memory device that includes some example peripheral circuits and a memory cell array, according to some aspects of the present disclosure.

FIG. 3 illustrates an example system for file management, according to some aspects of the present disclosure.

FIG. 4 an example process for migrating data from a source logical block address (LBA) to a destination LBA of a memory system, according to some aspects of the present disclosure.

FIG. 5 illustrates an example of a garbage collection of a file system in a host, according to some aspects of the present disclosure.

FIG. 6 illustrates an example process for data migration in a memory system, according to some aspects of the present disclosure.

FIG. 7A illustrates a diagram of a memory card having a memory device, according to some aspects of the present disclosure.

FIG. 7B illustrates a diagram of a solid-state drive (SSD) having a memory device, according to some aspects of the present disclosure.

Like reference numbers and designations in the various drawings indicate like elements.

### DETAILED DESCRIPTION

Data migration in a memory system can include a host sending a command to the memory system to establish a correspondence of data to a destination logical address based on a correspondence of the data to a source logical address. After the correspondence of the data to the destination logical address is established based on the correspondence of the data to the source logical address, the host can send a second command to the memory system to deallocate the source logical address. Sending the second command for the deallocation of the source logical address may lead to increased time associated with the data migration and decreased system performance during the data migration.

This specification relates to using a command sent from the host to the memory system to instruct the memory system to perform both the migration of data from a source logical address to a destination logical address and the deallocation of the source logical address. In some cases, the command can include a flag bit to indicate whether to deallocate the source logical address. An example of implementing the command is to add the flag bit to a copy command that complies with a protocol standard for non-volatile memory express (NVMe) (e.g., an NVMe 2.0 protocol standard).

Implementations of the present disclosure can provide one or more of the following technical effects. For example, the described techniques can reduce the number of commands between the host and the memory system for data migration. Consequently, the described techniques can reduce the time used to perform the data migration, and therefore, improve the overall performance of file system operations that involve data migration, for example, data defragmentation and/or garbage collection. Additionally, the described techniques can improve the efficiency of erasing invalid data after data migration. Furthermore, the aforementioned command can be compatible with the copy command that complies with the protocol standard for NVMe.

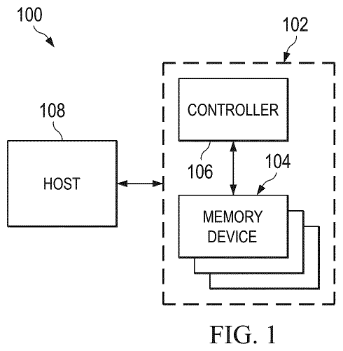

FIG. 1 illustrates a block diagram of an example system 100 having a memory device, according to some aspects of the present disclosure. System 100 can be a mobile phone, a desktop computer, a laptop computer, a tablet, a vehicle computer, a gaming console, a printer, a positioning device, a wearable electronic device, a smart sensor, a virtual reality (VR) device, an argument reality (AR) device, or any other suitable electronic devices having storage therein. As shown in FIG. 1, system 100 can include a host 108 and a memory system 102 having one or more memory devices 104 and a memory controller 106. Host 108 can be a processor of an electronic device, such as a central processing unit (CPU), or a system-on-chip (SoC), such as an application processor (AP). Host 108 can be configured to send or receive data to or from memory devices 104.

Memory device 104 can be any memory device disclosed in the present disclosure. Memory controller 106 is coupled to memory device 104 and host 108 and is configured to control memory device 104, according to some implementations. Memory controller 106 can manage the data stored in memory device 104 and communicate with host 108. In some implementations, memory controller 106 is designed for operating in a low duty-cycle environment like secure digital (SD) cards, compact Flash (CF) cards, universal serial bus (USB) Flash drives, or other media for use in electronic devices, such as personal computers, digital cameras, mobile phones, etc. In some implementations, memory controller 106 is designed for operating in a high duty-cycle environment SSDs or embedded multi-media-cards (eMMCs) used as data storage for mobile devices, such as smartphones, tablets, laptop computers, etc., and enterprise storage arrays. Memory controller 106 can be configured to control operations of memory device 104, such as read, erase, and program operations. Memory controller 106 can also be configured to manage various functions with respect to the data stored or to be stored in memory device 104 including, but not limited to bad-block management, garbage collection, logical-to-physical address conversion, wear leveling, etc. In some implementations, memory controller 106 is further configured to process error correction codes (ECCs) with respect to the data read from or written to memory device 104. Any other suitable functions may be performed by memory controller 106 as well, for example, formatting memory device 104.

Memory controller 106 can communicate with an external device (e.g., host 108) according to a particular communication protocol. For example, memory controller 106 may communicate with the external device through at least one of various interface protocols, such as a USB protocol, an MMC protocol, a peripheral component interconnection (PCI) protocol, a PCI-express (PCI-E) protocol, an advanced technology attachment (ATA) protocol, a serial-ATA protocol, a parallel-ATA protocol, a small computer small interface (SCSI) protocol, an enhanced small disk interface (ESDI) protocol, an integrated drive electronics (IDE) protocol, a Firewire protocol, etc.

Memory controller 106 and one or more memory devices 104 can be integrated into various types of storage devices, for example, be included in the same package, such as a universal Flash storage (UFS) package or an eMMC package. That is, memory system 102 can be implemented and packaged into different types of end electronic products. In one example, memory controller 106 and a single memory device 104 may be integrated into a memory card that can include a PC card (PCMCIA, personal computer memory card international association), a CF card, a smart media (SM) card, a memory stick, a multimedia card (MMC, RS-MMC, MMCmicro), an SD card (SD, miniSD, microSD, SDHC), a UFS, etc. The memory card can further include a memory card connector coupling the memory card with a host (e.g., host 108 in FIG. 1). In another example, memory controller 106 and multiple memory devices 104 may be integrated into an SSD that can further include an SSD connector coupling the SSD with a host (e.g., host 108 in FIG. 1). In some implementations, the storage capacity and/or the operation speed of the SSD is greater than those of the memory card.

In some implementations, a memory cell in memory device 104 is a single-level cell (SLC) that has two possible memory states and thus, can store one bit of data. For example, the first memory state “0” can correspond to a first range of voltages, and the second memory state “1” can correspond to a second range of voltages. In some implementations, each memory cell is a multi-level cell (MLC) that is capable of storing more than a single bit of data in more than four memory states. For example, the MLC can store two bits per cell, three bits per cell (also known as triple-level cell (TLC)), or four bits per cell (also known as a quad-level cell (QLC)). Each MLC can be programmed to assume a range of possible nominal storage values. In one example, if each MLC stores two bits of data, then the MLC can be programmed to assume one of three possible programming levels from an erased state by writing one of three possible nominal storage values to the cell. A fourth nominal storage value can be used for the erased state.

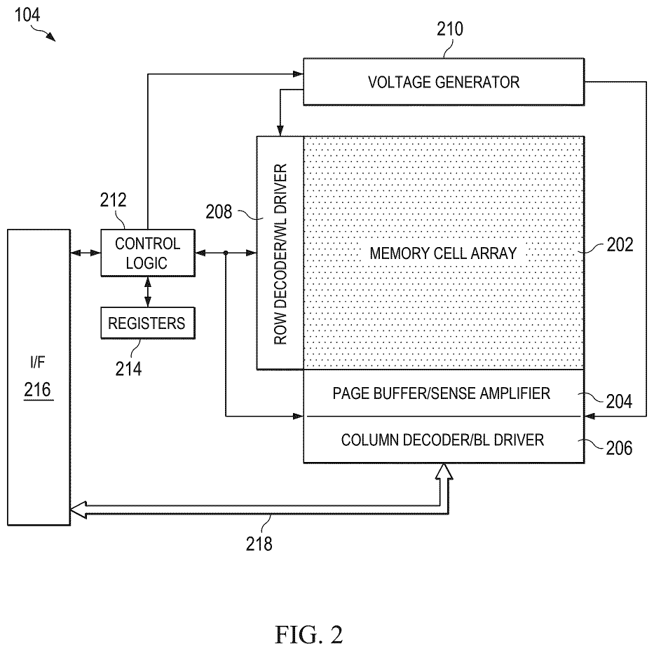

FIG. 2 illustrates an example memory device 104 that includes some example peripheral circuits and a memory cell array 202, according to some aspects of the present disclosure. The example peripheral circuits can include any suitable analog, digital, and mixed-signal circuits for facilitating the operations of memory cell array 202 by applying and sensing voltage signals and/or current signals to and from each target memory cell in memory cell array 202. As shown in FIG. 2, the example peripheral circuits can include a page buffer/sense amplifier 204, a column decoder/bit line driver 206, a row decoder/word line driver 208, a voltage generator 210, control logic 212, registers 214, an interface 216, and a data bus 218. In some examples, additional peripheral circuits not shown in FIG. 2 may be included as well.

Page buffer/sense amplifier 204 can be configured to read and program (write) data from and to memory cell array 202 according to the control signals from control logic 212. In one example, page buffer/sense amplifier 204 may store one page of program data (write data) to be programmed into one page of memory cell array 202. In another example, page buffer/sense amplifier 204 may perform program verify operations to ensure that the data has been properly programmed into memory cells of memory cell array 202. In still another example, page buffer/sense amplifier 204 may also sense the low power signals from a bit line that represents a data bit stored in a memory cell and amplify the small voltage swing to recognizable logic levels in a read operation. Column decoder/bit line driver 206 can be configured to be controlled by control logic 212 and select one or more NAND memory strings by applying bit line voltages generated from voltage generator 210.

Row decoder/word line driver 208 can be configured to be controlled by control logic 212 and select/deselect blocks of memory cell array 202 and select/deselect word lines of blocks of memory cell array 202. Row decoder/word line driver 208 can be further configured to drive word lines using word line voltages generated from voltage generator 210. In some implementations, row decoder/word line driver 208 can also select/deselect and drive source select gate (SSG) lines and drain select gate (DSG) lines as well. Row decoder/word line driver 208 can be configured to apply a read voltage to a selected word line in a read operation on a memory cell coupled to the selected word line.

Voltage generator 210 can be configured to be controlled by control logic 212 and generate the word line voltages (e.g., read voltage, program voltage, pass voltage, local voltage, verification voltage, etc.), bit line voltages, and source line voltages to be supplied to memory cell array 202.

Control logic 212 can be coupled to each peripheral circuit described above and configured to control operations of each peripheral circuit. Registers 214 can be coupled to control logic 212 and include status registers, command registers, and address registers for storing status information, command operation codes (OP codes), and command addresses for controlling the operations of each peripheral circuit. The status registers of registers 214 can include one or more registers configured to store open block information indicative of the open block(s) of all blocks in memory cell array 202, such as having an auto dynamic start voltage (ADSV) list. In some implementations, the open block information is also indicative of the last programmed page of each open block.

Interface 216 can be coupled to control logic 212 and act as a control buffer to buffer and relay control commands received from a host (e.g., host 108 in FIG. 1) to control logic 212 and status information received from control logic 212 to the host. Interface 216 can also be coupled to column decoder/bit line driver 206 via a data bus 218 and act as a data input/output (I/O) interface and a data buffer to buffer and relay the data to and from memory cell array 202.

In some implementations, in program operations, page buffer/sense amplifier 204 can include storage modules (e.g., latches) for temporarily storing a piece of N-bits data (e.g., in the form of gray codes) received from data bus 218 and providing the piece of N-bits data to a corresponding target memory cell in a first pass (a non-last program pass, e.g., a coarse program pass) of a multi-pass program operation. Prior to a second pass after the first pass (the last program pass, e.g., a fine program pass), in a read operation, page buffer/sense amplifier 204 can be configured to read one or more (M) bits of the piece of N-bits data based on the corresponding intermediate level in which the target memory cell is programmed into the first pass and also receive the remaining (N−M) bits of the piece of N-bits data from a memory controller (e.g., 106 in FIG. 1). Page buffer/sense amplifier 204 can then be configured to combine the read bits and the received bits into the corresponding piece of N-bits data and provide the corresponding piece of N-bits data to the target memory cell in the second first pass. Therefore, in these implementations, the remaining (N−M) bits of the piece of N-bits data need to be received from a memory controller.

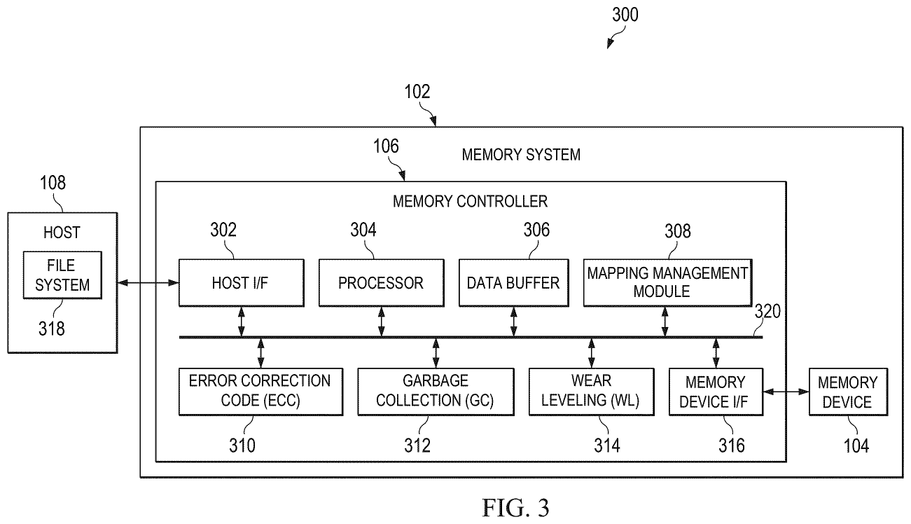

FIG. 3 illustrates an example system 300 for file management. In some implementations, memory controller 106 can be configured to perform operations to manage data stored or to be stored in memory device 104, for example, mapping management, bad-block management, garbage collection, and/or wear leveling. Memory controller 106 can also perform any other suitable operations, for example, formatting memory device 104. Memory controller 106 can include host interface (host I/F) 302, memory device interface (memory device I/F) 316, one or more processors 304, error correction code (ECC) module 310, garbage collection (GC) module 312, wear leveling (WL) module 314, mapping management module 308, data buffer 306, and/or data buses 320.

In some implementations, host I/F 302 is an interface between host 108 and memory controller 106. Host I/F 302 can enable communication between host 108 and memory controller 106 according to a particular communication protocol and receive read requests, write requests, and/or other operation requests. Host I/F 302 of memory controller 106 may communicate with external devices (e.g., host 108) according to particular communication protocols. For example, host I/F 302 of memory controller 106 may communicate with external devices through at least one of various interface protocols, such as a USB protocol, an MMC protocol, a peripheral component interconnection (PCI) protocol, a PCI-express (PCI-E) protocol, an advanced technology attachment (ATA) protocol, a serial-ATA protocol, a parallel-ATA protocol, a small computer small interface (SCSI) protocol, an enhanced small disk interface (ESDI) protocol, an integrated drive electronics (IDE) protocol, a Firewire protocol, etc.

In some implementations, memory device I/F 316 is an interface between memory controller 106 and memory device 104. Memory device I/F 316 can be used to implement data and/or command transfer between memory controller 106 and memory device 104.

In some implementations, one or more processors 304 can be used to control memory system 102. Operations performed by memory controller 106 can be executed and completed by one or more processors 304. In some cases, one or more processors 304 can include a CPU and/or a microcontroller unit (MCU).

In some implementations, ECC module 310 can further include an encoder and a decoder. The encoder can be used to encode data stored in memory device 104 to obtain validation data. The decoder can be used to decode the validation data to detect and/or correct potential errors in data during the transfer of the data.

In some implementations, after storage space of memory device 104 reaches a certain threshold, GC module 312 can be used to read, rewrite, and mark one or more storage blocks in memory device 104, in order to obtain new spare storage blocks. In some cases, garbage collection can include selecting source storage blocks with relatively less amount of valid data, finding the valid data from the source storage blocks, and writing the valid data to target storage blocks. Consequently, all the data in the source storage blocks become invalid data. The source storage blocks are marked and can be used as new spare storage blocks.

In some implementations, WL module 314 can be used to evenly distribute the wear (e.g., the number of erasures) of each storage block in memory system 102, based on data statistics and/or corresponding algorithms. In some cases, wear leveling can include selecting source storage blocks that contain cold data, reading valid data from the source storage blocks, and writing the valid data to storage blocks with relatively larger number of erasures. Consequently, the valid data in the source storage blocks becomes invalid data and can be marked as invalid.

In some implementations, data buffer 306 can be used to cache data.

In some implementations, in response to write requests from host 108, memory controller 106 can allocate physical storage space of memory system 102 for data from host 108, and record and manage the mapping from a logical address in file system 318 to the corresponding physical storage space. Memory controller 106 can include mapping management module 308 that performs the conversion or mapping from the logical address to the physical storage space.

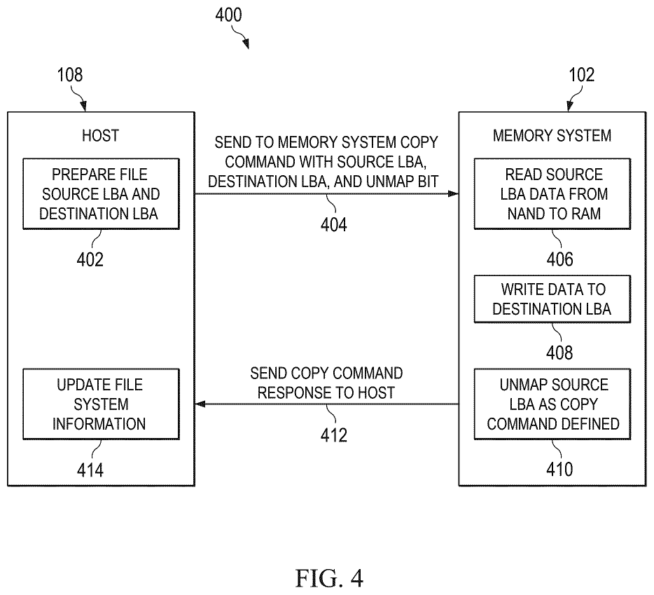

FIG. 4 illustrates an example process 400 for migrating data from a source LBA (e.g., a first logical address) to a destination LBA (e.g., a second logical address) of a memory system. In some implementations, the data can be in one or more files. An example of the memory system is memory system 102 in FIG. 1. In some cases, the memory system can be an NVMe device or a universal flash storage (UFS) device. A host, for example, host 108 in FIG. 1, can communicate with the memory system, for example, through 404 and 412, to move data from the source LBA to the destination LBA in the memory system. The memory system can move data from the source LBA to the destination LBA by performing one or more operations, for example, operations at 406, 408, and 410. The one or more operations can be implemented using firmware of the memory system. In some cases, the memory system can be a cloud-based memory system.

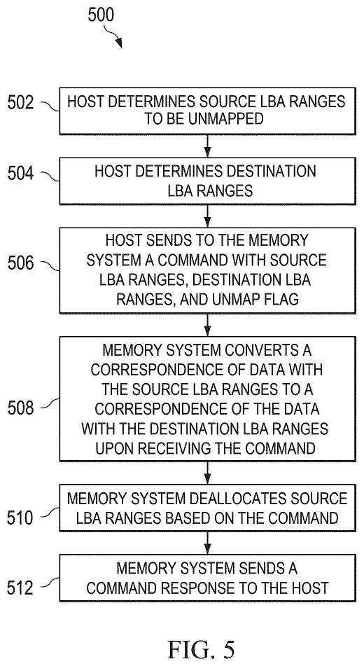

At 402, host 108 prepares the source LBA and the destination LBA of the data, for example, by identifying the source LBA and the destination LBA. In some implementations, the source LBA and the destination LBA of memory system 102 can be associated with one or more operations in memory system 102, for example, garbage collection and/or defragmentation in memory system 102. An example process of garbage collection in memory system 102 is illustrated in FIG. 5 and described later.

In some implementations, host 108 can have an interface that includes a driver and an interconnector. The interconnector can be coupled to the driver and memory system 102 through one or more communication buses. The driver can generate, based on a request from an operating system in host 108, a command that complies with protocol standards. The interconnector can transfer the command from host 108 to memory system 102 through a communication bus.

At 404, host 108 send a command to memory system 102, for example, through a communication bus, to move the data from the source LBA to the destination LBA in memory system 102. In some implementations, the command can include the source LBA, the destination LBA, and a flag bit, for example, an unmap bit. The flag bit can indicate whether to deallocate the source LBA in memory system 102. In some cases, when the value of the flag bit (e.g., a first value) indicates to deallocate the source LBA, for example, when the value of the flag bit is logical 1, memory system 102 deallocates the source LBA. When the value of the flag bit (e.g., a second value) indicates to not deallocate the source LBA, for example, when the value of the flag bit is logical 0, memory system 102 retains the correspondence of the data to the source LBA.

In some implementations, the command can be implemented by modifying a copy command that complies with a protocol standard for NVMe (e.g., an NVMe 2.0 protocol standard), for example, by adding the flag bit to the copy command. In some cases, the command can be implemented by modifying a small computer system interface (SCSI) command that complies with a protocol standard for UFS, for example, by adding the flag bit to the SCSI command.

In some implementations, the command can be received by a memory controller, for example, memory controller 106, in memory system 102. The memory controller can include an interface (e.g., a first interface) that receives the command from host 108. The interface can also decode the received command to retrieve the source LBA, the destination LBA, and the flag bit.

In some implementations, the command sent at 404 from host 108 to memory system 102 can be used to detect whether the command includes the flag bit.

At 406, the memory controller in memory system 102 reads the data corresponding to the source LBA from a first physical storage space of memory system 102 to a cache, for example, a random access memory (RAM), of memory system 102. The first physical storage space can be one or more pages in one or more memory devices of memory system 102, for example, memory devices 104. An example of the one or more memory devices can be NAND memory devices.

At 408, the memory controller writes the data corresponding to the source LBA to the destination LBA. The memory controller can write the data using one or more processors in the memory controller. In some implementations, writing the data to the destination LBA can include writing the data from the cache to a second physical storage space of memory system 102. In some cases, writing the data to the destination LBA can include establishing a correspondence of the data to the destination LBA based on the correspondence of the data to the source LBA. In some cases, the memory controller can establish, for example, using mapping management module 308 in FIG. 3, a mapping relationship between the destination LBA and the second physical storage space. The mapping relationship can be stored in a table, for example, in a RAM in memory controller 106. A copy of the mapping relationship can also be stored in memory device 104.

In some implementations, instead of performing the operations at 406 and 408 described above, the memory controller can establish, for example, using mapping management module 308 in FIG. 3, the correspondence of the data to the destination LBA by mapping the destination LBA with the first physical storage space of memory system 102.

At 410, the memory controller determines whether to deallocate the source LBA based on the flag bit in the command. The memory controller can deallocate the source LBA using the one or more processors in the memory controller. In some implementations, deallocating the source LBA corresponding to the data can include cancelling the correspondence of the data to the source LBA, and therefore, host 108 can no longer access the data using the correspondence of the data to the source LBA. In some cases, deallocating the source LBA can include marking, for example, using mapping management module 308 in FIG. 3, a mapping relationship between the source LBA and the first physical storage space of memory system 102 corresponding to the source LBA as invalid, where the data was stored in the first physical storage space of memory system 102 before the source LBA is deallocated, and the mapping relationship can be stored in a table, for example, in a RAM in memory controller 106. A copy of the mapping relationship can also be stored in memory device 104. Because the mapping relationship is marked as invalid, host 108 can no longer access the data using the source LBA.

In some implementations, deallocating the source LBA corresponding to the data can also include receiving a command from host 108 to memory system 102 that indicates that the data corresponding to the source LBA and in the first physical storage space of memory system 102 is no longer valid. Memory system 102 can then mark pages in the first physical storage space that store the data as invalid. Consequently, when performing other operations, for example, garbage collection, memory system 102 can discard the data in the first physical storage space, without migrating the data in the first physical storage space to another physical storage space of memory system 102 during garbage collection. In some cases, deallocating the source LBA can also include updating the total number of pages that have valid data.

In some implementations, when the value of the flag bit indicates to deallocate the source LBA, for example, when the value of the flag bit is logical 1, the memory controller deallocates the source LBA. When the value of the flag bit indicates to not deallocate the source LBA, for example, when the value of the flag bit is logical 0, the memory controller retains the correspondence of the data to the source LBA and does not deallocate the source LBA. Therefore, when the value of the flag bit is logical 0, the command is equivalent to the copy command that complies with the protocol standard for NVMe (e.g., an NVMe 2.0 protocol standard), and consequently, the command disclosed above is compatible with the copy command that complies with the protocol standard for NVMe.

At 412, the memory controller sends a response to the command to host 108, in response to a completion of an execution of the command. In some implementations, the response can indicate that memory system 102 has written the data to the destination LBA, and the source LBA has been deallocated. In some cases, the response can indicate that memory system 102 has retained the correspondence of the data to the source LBA and the source LBA has not been deallocated.

In some implementations, after the completion of the execution of the command, when memory system 102 receives from host 108 a read command instructing reading out the data originally corresponding to the source LBA (e.g., the data corresponding to the source LBA before the source LBA is deallocated), memory system 102 can return invalid data or other data different from the data originally corresponding to the source LBA, to indicate that the source LBA has been deallocated.

At 414, host 108 updates file system information to indicate whether the data corresponds to the source LBA or the destination LBA, based on the response received from the memory controller.

FIG. 5 illustrates an example 500 of a garbage collection of a file system in a host. For convenience, process 500 will be described as being performed by a system that includes a host and a memory system coupled to the host. An example of the host is host 108 in FIG. 1 or FIG. 4. An example of the memory system is memory system 102 in FIG. 1 or FIG. 4. In some cases, the memory system can be an NVMe device or a UFS device. The garbage collection can include converting a correspondence of data with source LBA ranges to a correspondence of the data with destination LBA ranges, followed by deallocating the source LBA ranges. In some cases, the garbage collection can be performed by GC module 312 in FIG. 3. In some implementations, operations illustrated in example 500 can also be applied to data defragmentation of the file system.

At 502, the file system in the host determines the source LBA ranges that are to be deallocated or unmapped during the garbage collection. In some cases, the source LBA ranges can correspond to the source LBA described in FIG. 4. The correspondence of the data with the source LBA ranges will be converted to a correspondence of the data with the destination LBA ranges during the garbage collection.

At 504, the file system in the host determines the destination LBA ranges. In some cases, the destination LBA ranges can correspond to the destination LBA described in FIG. 4.

At 506, the host sends a command to the memory system. The command can include the source LBA ranges, the destination LBA ranges, and an unmap flag. An example of the unmap flag is the flag bit described in FIG. 4. The unmap flag can indicate whether to deallocate the source LBA ranges.

At 508, after receiving the command, the memory system converts the correspondence of data with the source LBA ranges to the correspondence of the data with the destination LBA ranges. In some implementations, the conversion can include operations at 406 and 408 of FIG. 4 described above. In some cases, the conversion can include mapping, for example, using mapping management module 308 in FIG. 3, the destination LBA ranges with a first physical storage space of memory system 102 that corresponds to the source LBA ranges.

At 510, the memory system deallocates the source LBA ranges based on the unmap bit in the command. In some implementations, if the unmap flag indicates to deallocate the source LBA ranges, for example, when the value of the unmap flag is logical 1, the memory system deallocates the source LBA ranges. If the value of the unmap flag indicates to not deallocate the source LBA ranges, for example, when the value of the unmap flag is logical 0, the memory system retains the correspondence of the data to the source LBA ranges and does not deallocate the source LBA ranges. In some cases, the deallocation can include operations at 410 of FIG. 4 described above.

At 512, the memory system sends to the host, a response to the command, in response to a completion of an execution of the command. An example of the response can be the response sent at 412 of FIG. 4 described above. In some implementations, the response can indicate that memory system 102 has completed the garbage collection, and the source LBA ranges have been deallocated. In some cases, the response can indicate that memory system 102 has completed the garbage collection, but retained the correspondence of the data to the source LBA, and therefore the source LBA ranges have not been deallocated.

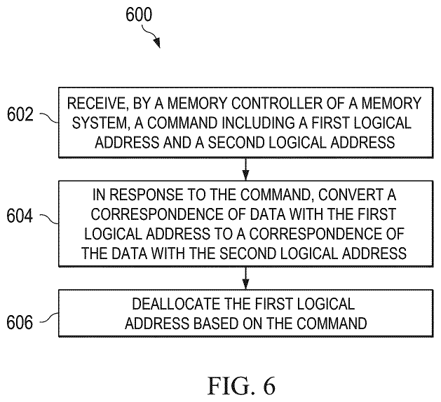

FIG. 6 illustrates an example process 600 for data migration in a memory system, according to some aspects of the present disclosure. Process 600 can be performed by any suitable device or system as described herein, for example, according to the example techniques described with respect to FIGS. 4-5. For example, process 600 can be performed by a memory system, such as memory system 102. The memory system can be a part of a system, such as system 100. The operations shown in process 600 may not be exhaustive and that other operations can be performed as well before, after, or in between any of the illustrated operations. Further, some of the operations may be performed simultaneously, or in a different order than shown in FIG. 6. In some implementations, some of the operations may be performed by one or more components of a device or a system, such as, a memory controller of the memory system.

At 602, a memory controller of a memory system receives a command that includes a first logical address and a second logical address.

At 604, in response to the command, the memory controller establishes a correspondence of data to the second logical address based on a correspondence of the data to the first logical address.

At 606, the memory controller deallocates the first logical address based on the command.

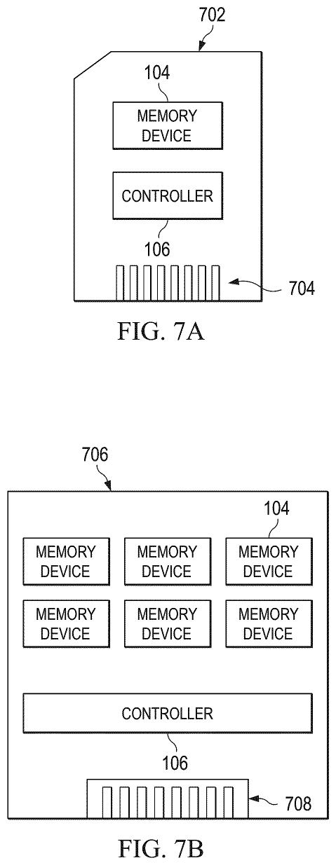

Memory controller 106 and one or more memory devices 104 can be integrated into various types of storage devices, for example, be included in the same package, such as a universal Flash storage (UFS) package or an eMMC package. That is, memory system 102 can be implemented and packaged into different types of end electronic products. In one example shown in FIG. 7A, memory controller 106 and a single memory device 104 may be integrated into a memory card 702. Memory card 702 can include a PC card (PCMCIA, personal computer memory card international association), a CF card, a smart media (SM) card, a memory stick, a multimedia card (MMC, RS-MMC, MMCmicro), an SD card (SD, miniSD, microSD, SDHC), a UFS, etc. Memory card 702 can further include a memory card connector 704 coupling memory card 702 with a host (e.g., host 108 in FIG. 1). In another example shown in FIG. 7B, memory controller 106 and multiple memory devices 104 may be integrated into an SSD 706. SSD 706 can further include an SSD connector 708 coupling SSD 706 with a host (e.g., host 108 in FIG. 1). In some implementations, the storage capacity and/or the operation speed of SSD 706 is greater than those of memory card 702.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

As used in this disclosure, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

As used in this disclosure, the term “about” or “approximately” can allow for a degree of variability in a value or range, for example, within 10%, within 5%, or within 1% of a stated value or of a stated limit of a range.

As used in this disclosure, the term “substantially” refers to a majority of, or mostly, as in at least about 50%, 60%, 70%, 80%, 90%, 95%, 96%, 97%, 98%, 99%, 99.5%, 99.9%, 99.99%, or at least about 99.999% or more.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “0.1% to about 5%” or “0.1% to 5%” should be interpreted to include about 0.1% to about 5%, as well as the individual values (for example, 1%, 2%, 3%, and 4%) and the sub-ranges (for example, 0.1% to 0.5%, 1.1% to 2.2%, 3.3% to 4.4%) within the indicated range. The statement “X to Y” has the same meaning as “about X to about Y,” unless indicated otherwise. Likewise, the statement “X, Y, or Z” has the same meaning as “about X, about Y, or about Z,” unless indicated otherwise.

Implementations of the subject matter and the functional operations described in this specification can be implemented in digital electronic circuitry, in tangibly embodied computer software or firmware; in computer hardware, including the structures disclosed in this specification and their structural equivalents; or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. For example, the signal can be a machine-generated electrical, optical, or electromagnetic signal that is generated to encode information for transmission to a suitable receiver apparatus for execution by a data processing apparatus. The computer-storage medium can be a machine-readable storage device, a machine-readable storage substrate, a random or serial access memory device, or a combination of computer-storage mediums.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks. Computer readable media can also include magneto optical disks, optical memory devices, and technologies including, for example, digital video disc (DVD), CD ROM, DVD+/-R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Particular implementations of the subject matter have been described. Other implementations, alterations, and permutations of the described implementations are within the scope of the following claims as will be apparent to those skilled in the art. While operations are depicted in the drawings or claims in a particular order, such operations are not required be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations are not required in all implementations, and the described components and systems can generally be integrated together or packaged into multiple products.

Accordingly, the previously described example implementations do not define or constrain the present disclosure. Other changes, substitutions, and alterations are also possible without departing from the spirit and scope of the present disclosure.

What is claimed is:

1. A system, comprising:
a host configured to send a command comprising a first logical address and a second logical address; and
a memory system coupled to the host and configured to:
receive the command;
in response to the command, establish a correspondence of data to the second logical address based on a correspondence of the data to the first logical address; and
deallocate the first logical address based on the command.

2. The system of claim 1, wherein establishing the correspondence of the data to the second logical address based on the correspondence of the data to the first logical address comprises:
reading the data from a first physical storage space of the memory system corresponding to the first logical address;
writing the data to a second physical storage space of the memory system; and
establishing a mapping relationship between the second logical address and the second physical storage space.

3. The system of claim 1, wherein establishing the correspondence of the data to the second logical address based on the correspondence of the data to the first logical address comprises:
establishing a mapping relationship between the second logical address and a first physical storage space of the memory system corresponding to the first logical address.

4. The system of claim 1, wherein deallocating the first logical address based on the command comprises:
cancelling the correspondence of the data to the first logical address.

5. The system of claim 1, wherein the command comprises a flag bit indicating whether to deallocate the first logical address.

6. The system of claim 5, wherein the memory system is configured to:
in response to the flag bit comprising a first value, deallocate the first logical address.

7. The system of claim 5, wherein the memory system is configured to:
in response to the flag bit comprising a second value, retain the correspondence of the data to the first logical address.

8. The system of claim 5, wherein the command comprises a copy command having the flag bit

9. The system of claim 1, wherein the memory system is further configured to:
in response to a completion of an execution of the command, send a response signal to the host; and
upon receiving a read command instructing reading out the data corresponding to the first logical address following the completion of the execution of the command, return an invalid data or other data different from the data.

10. The system of claim 1, wherein the host comprises an interface comprising a driver and an interconnector, the interconnector coupled to the driver and the memory system, and wherein:
the driver is configured to generate the command that complies with protocol standards based on a request from an operating system in the host; and
the interconnector is configured to transfer the command to the memory system through a communication bus.

11. A memory system, comprising:
a non-volatile memory device; and
a memory controller coupled to the non-volatile memory device and configured to:
receive a command comprising a first logical address and a second logical address;
in response to the command, establish a correspondence of data to the second logical address based on a correspondence of the data to the first logical address; and
deallocate the first logical address based on the command.

12. The memory system of claim 11, wherein the memory controller comprises:
a first interface coupled to a host and configured to:
receive the command, and
decode the command; and
a processor coupled to the first interface and configured to establish the correspondence of the data to the second logical address based on the correspondence of the data to the first logical address and deallocate the first logical address based on the command.

13. The memory system of claim 12, wherein establishing the correspondence of the data to the second logical address based on the correspondence of the data to the first logical address comprises:
sending, to the non-volatile memory device, a read command to read the data from a first physical storage space of the non-volatile memory device;
sending, to the non-volatile memory device, a write command to write the data to a second physical storage space of the non-volatile memory device; and
establishing a mapping relationship between the second logical address and the second physical storage space.

14. The memory system of claim 12, wherein establishing the correspondence of the data to the second logical address based on the correspondence of the data to the first logical address comprises:
establishing a mapping relationship between the second logical address and a first physical storage space of the non-volatile memory device corresponding to the first logical address.

15. The memory system of claim 11, wherein deallocating the first logical address based on the command comprises:
cancelling the correspondence of the data to the first logical address.

16. The memory system of claim 11, wherein the command comprises a flag bit indicating whether to deallocate the first logical address.

17. A method of operating a memory system, comprising:
receiving, by a memory controller of the memory system, a command comprising a first logical address and a second logical address;
in response to the command, establishing a correspondence of data to the second logical address based on a correspondence of the data to the first logical address; and
deallocating the first logical address based on the command.

18. The method of claim 17, wherein establishing the correspondence of the data to the second logical address based on the correspondence of the data to the first logical address comprises:
reading the data from a first physical storage space of a non-volatile memory device of the memory system corresponding to the first logical address;
writing the data to a second physical storage space of the non-volatile memory device; and
establishing a mapping relationship between the second logical address and the second physical storage space.

19. The method of claim 17, wherein establishing the correspondence of the data to the second logical address based on the correspondence of the data to the first logical address comprises:
establishing a mapping relationship between the second logical address and a first physical storage space of a non-volatile memory device of the memory system corresponding to the first logical address.

20. The method of claim 17, wherein deallocating the first logical address based on the command comprises:
cancelling the correspondence of the data to the first logical address.
